(19) United States
(12) Patent Application Publication
(10) Pub. No.: US 2002/0183410 A1
(43) Pub. Date: Dec. 5, 2002

(54) System and method for curing reactive material

(76) Inventor: Patrick O'Connor, Toronto (CA)

Correspondence Address: Shawn D. Jacka, Bereskin & Parr, Box 401, 40 King Street West, Toronto, ON, M5H 3Y2, CA

(21) Appl. No.: 09/873,365

(22) Filed: Jun. 5, 2001

(51) Int. Cl. C08G 2/00

(52) U.S. Cl. 522/1; 425/174

(57) ABSTRACT

A method and system for curing reactive material. The system includes an inlet port adapted to receive radiation from a source, at least one emitter port, and transmission means operatively coupling the inlet port to each emitter port. The transmission means is adapted to conduct radiation from the inlet port to the emitter ports. Preferably, the emitter port is configured in a shape approximating the surface area of the curable material. The method includes the steps of providing a curing system made in accordance with the present invention, positioning the reactive material proximate the emitter port, and directing radiation within the absorption spectrum of the reactive material into the inlet port until the reactive material is sufficiently cured.

### FIELD OF THE INVENTION

The present invention relates generally to the field of curing polymeric materials, with common but by no means exclusive application to manufacturing techniques for curing two sides of a reactive object. For greater clarity, when used herein, reference to “curable” and “reactive” materials and variations thereof is intended to mean polymeric materials which chemically transform with the application of sufficient energy, unless a contrary intention is apparent.

### BACKGROUND OF THE INVENTION

Manufacturing microelectronic and optoelectronic components often involves the use of minute quantities of reactive adhesives to join components together. Many prior art systems for curing such adhesives are imprecise in directing energy to the reactive material, including onto other components. Such imprecision generally requires a lower power of radiation to be emitted, to reduce the risk of damage to the device.

Accordingly, the inventors have recognized a need for a system and method which are capable of efficiently directing curing radiation onto workpieces.

### SUMMARY OF THE INVENTION

This invention is directed towards a system for curing reactive material.

The system includes an inlet port adapted to receive radiation from a source, at least one emitter port, and transmission means operatively coupling the inlet port to each emitter port. The transmission means is adapted to conduct radiation from the inlet port to the emitter ports. Preferably, the emitter port is configured in a shape approximating the surface area of the curable material.

The invention is further directed towards a method for curing reactive material. The method includes the steps of:

(a) providing a curing system made in accordance with the present invention;

(b) positioning the reactive material proximate the emitter port; and

(c) directing radiation within the absorption spectrum of the reactive material into the inlet port until the reactive material is sufficiently cured.

### BRIEF DESCRIPTION OF THE DRAWINGS

The present invention will now be described, by way of example only, with reference to the following drawings, in which like reference numerals refer to like parts and in which:

FIG. 1A is a top perspective view of a first embodiment of the curing system made in accordance with the present invention.

FIG. 1B is an expanded end view of the input port of the curing system of FIG. 1A.

FIG. 2 is a top view of the curing system of FIG. 1A.

FIG. 3 is an expanded side view of an emitter port of the curing system of FIG. 1A.

FIG. 4 is a top perspective view of a second embodiment of the curing system made in accordance with the present invention.

FIG. 5 is a top perspective view of a third embodiment of the curing system made in accordance with the present invention.

FIG. 6 is a logical flow diagram of a curing method carried out by the curing system made in accordance with the present invention.

### DESCRIPTION OF THE PREFERRED EMBODIMENTS

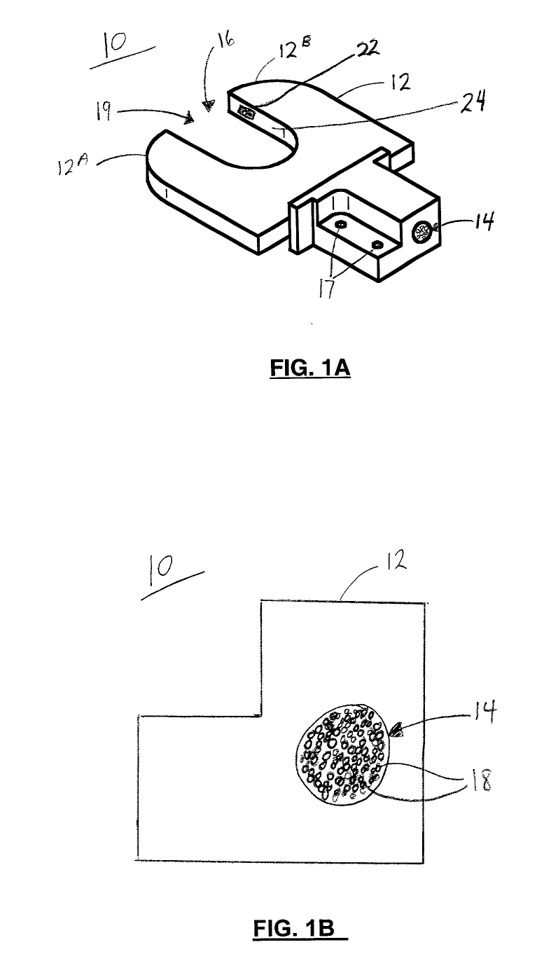

Referring simultaneously to FIGS. 1A and 1B, illustrated therein is a first embodiment of the curing system of the subject invention. The curing system, shown generally as 10, includes a housing 12, an inlet port 14 and an irradiation zone 16.

The housing 12 is typically made of metal or other material selected to be largely unaffected by the heat generated by the curing process. The housing 12 is generally forked or horseshoe shaped having a first arm 12^{A} and a second arm 12^{B}; however, as will be understood, alternate configurations of the housing 12 may be used depending on the requirements of the curing application. The housing 12 may also include mounting holes 17 for mounting the system 10 to a fixed or moveable platform such as a robotic arm.

As illustrated in FIG. 1B, optical fibre filaments 18, typically approximately 245 micrometers in diameter are compressed into the mouth of the inlet port 14 and adhered together. The ends of the filaments 18 are ground and polished smooth to maximize optical transmission from a radiation source (typically a standard light guide). The inlet port 14 is generally circular in shape, and preferably configured to mate with the metal ferrule of a standard light guide, using a coupler, as will be understood. Preferably the fibre filaments 18 are made of quartz or other standard optical fibre material, adapted to receive and transmit radiation suitable for curing reactive materials.

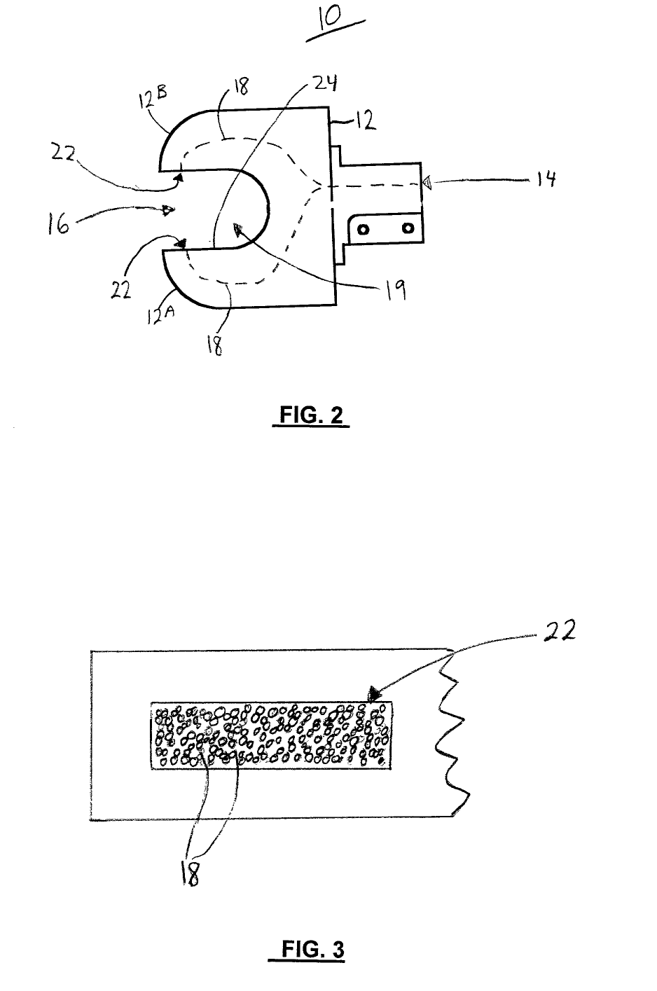

Referring now to FIG. 2, the first arm 12^{A} and second arm 12^{B} form a gap 19 which is generally U-shaped, containing the irradiation zone 16. The gap 19 is preferably sized to receive a workpiece containing reactive material to be cured. Two emitter ports 22 are positioned on the interior wall 24 of the irradiation zone 16.

The emitter ports 22 are generally opposed, and adapted to direct radiation towards each other. In this configuration, two sides of a workpiece may be cured simultaneously. However, the emitter ports 22 may also be configured to emit radiation in the same general direction, to cure different surface areas of a workpiece at the same time, depending on the curing requirements of the workpiece. In a configuration in which the emitter ports 22 emit radiation in similar directions, it may not be necessary to have two arms 12^{A}, 12^{B}—a single curing arm may be sufficient.

As shown in FIG. 3, each emitter port 22 is substantially rectangular in shape. Since the workpiece is positioned in close proximity to the emitter ports 22 during the curing process, preferably the shape of the emitter ports 22 is selected to closely match (or even slightly exceed) the surface area of the reactive material. Accordingly, it should be understood that the emitter ports 22 may have shapes other than rectangles, including free-form shapes.

The second end of each emitter fibre 18 terminates at an emitter port 22, where it is compressed into the shape of the emitter port 22 and adhered to the other fibres 18 at that emitter port 22. As with the inlet port 14, the ends of the fibres 18 are ground and polished smooth to maximize optical transmission. The optical fibres 18 function to transmit radiation received from a radiation source at the inlet port 14 to the emitter ports 22.

Since the radiation source may not provide radiation uniformly into the inlet port 14, it is preferable if the second ends of the optical fibre filaments 18 are randomly distributed between the various emitter ports 22, once the first ends are positioned at the inlet port 14. Random distribution of the fibre filaments 18 will help ensure that the radiation emitted by the various emitter ports 22 is substantially uniform, as will be understood. The two bundles of optical fibre filaments 18 corresponding to each emitter port 22 are housed within the housing 12, and are illustrated schematically as dotted lines on FIG. 2.

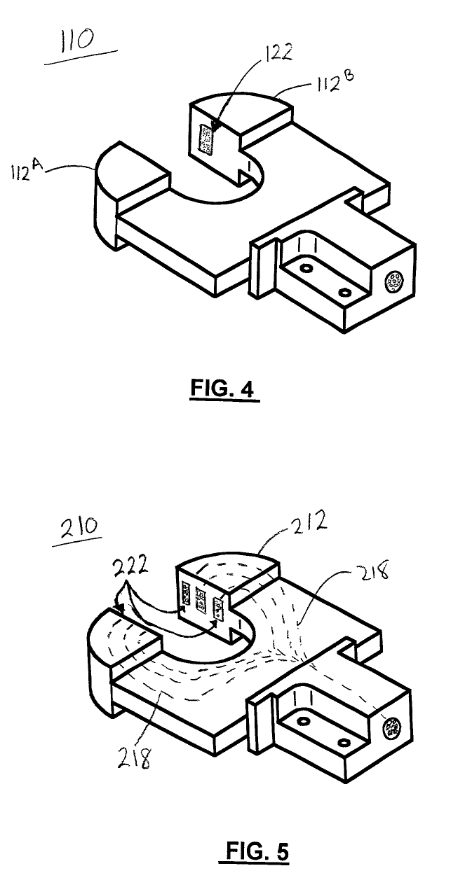

Illustrated in FIG. 4 is a second embodiment of the curing system of the subject invention. The second embodiment, shown generally as 110, is substantially similar to the first embodiment 10, with the main exception being that the length of the emitter ports 122 is substantially perpendicular to the longitudinal axis of the first 112^{A} and second 112^{B} arms. As will be understood, the housing 112 differs from the housing 12 of the first embodiment 10 to accommodate the vertical orientation (relative to the housing 112) of the emitter ports 122.

Illustrated in FIG. 5 is a third embodiment of the curing system of the subject invention. The third embodiment, shown generally as 210, is substantially similar to the second embodiment 110, with the main exception being that the system 210 includes six emitter ports 222. The six bundles of optical fibre filaments 218 corresponding to each emitter port 222 are housed within the housing 212, and are illustrated schematically as dotted lines on FIG. 5.

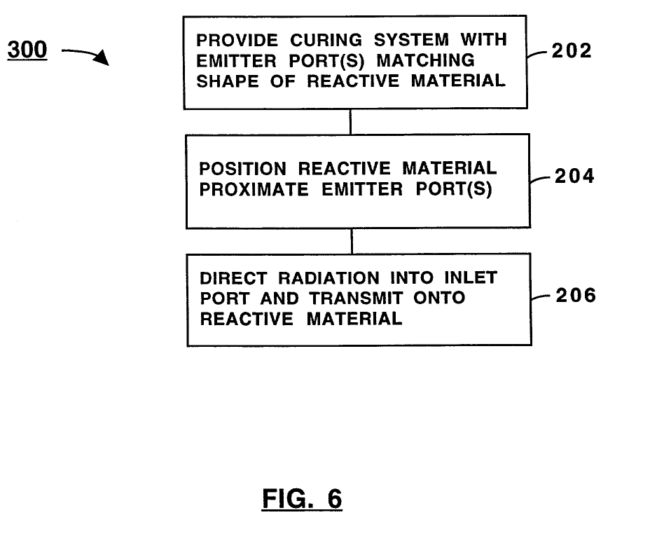

FIG. 6 illustrates the steps of the method 300 carried out by the curing systems 10, 110, 210 in use and made in accordance with the subject invention. The user typically first provides a curing system of the present invention. Preferably the emitter port(s) is shaped to substantially match the surface area of the reactive material to be cured. (Block 202) The reactive material is then positioned proximate the emitter port(s). (Block 204) Radiation within the absorption spectrum of the reactive material is then directed into the inlet port and transmitted out the emitter port(s) onto the reactive material until the reactive material is sufficiently cured. (Block 206)

As will be understood, while the gaps 19 have been disclosed as being U-shaped, it should be understood that different configurations are possible, depending on the configuration of the workpiece to be cured. Additionally, while the three embodiments 10, 110, 210 have been illustrated as having one, one and three pairs of opposed emitter ports respectively, it should be understood that other numbers and configurations of emitter ports are possible. As will be understood, it is possible to have only a single emitter port designed to reshape the radiation received from the inlet port to more precisely match the shape of the material to be cured.

Thus, while what is shown and described herein constitute preferred embodiments of the subject invention, it should be understood that various changes can be made without departing from the subject invention, the scope of which is defined in the appended claims.

I claim:

1. A system for curing curable material, the system comprising:
(a) an inlet port adapted to receive radiation from a source;
(b) at least one emitter port;
(c) transmission means operatively coupling the inlet port to each emitter port;
(d) wherein the transmission means is adapted to conduct radiation from the inlet port to the emitter port.

2. The system as claimed in claim 1, wherein the inlet port is adapted to receive the emitting end of a light guide.

3. The system as claimed in claim 1, wherein the inlet port is adapted to releasably engage a metal ferrule of a light guide.

4. The system as claimed in claim 1, wherein the configuration of the emitter port is correlated to the shape of the curable material.

5. The system as claimed in claim 4, wherein the configuration of the emitter port substantially matches the shape of the curable material.

6. The system as claimed in claim 4, wherein the emitter port is configured in a shape approximating the surface area of the curable material.

7. The system as claimed in claim 4, wherein the dimensions of the emitter port are at least as great as the surface area dimensions of the curable material.

8. The system as claimed in claim 1, comprising at least two emitter ports.

9. The system as claimed in claim 1, comprising a first emitter port and a second emitter port remote from the first emitter port, wherein the first emitter port is substantially opposed to the second emitter port.

10. The system as claimed in claim 9 further comprising a housing, wherein the housing comprises a first arm and a second arm, and wherein the first arm and the second arm form a gap between them, and wherein a first emitter port is positioned on the first arm and a second emitter port is positioned on the second arm.

11. The system as claimed in claim 9, wherein the gap is configured to receive a workpiece comprising the curable material.

12. The system as claimed in claim 1, wherein the transmission means comprises a plurality of optical fibre strands.

13. The system as claimed in claim 12, wherein each optical fibre strand comprises a first end positioned proximate the inlet port, and a second end positioned proximate an emitter port.

14. The system as claimed in claim 13, wherein the second end of each optical fibre strand is substantially randomly assigned to an emitter port.

15. The system as claimed in claim 1, wherein the emitter port is substantially rectangular in shape.

16. A method for curing reactive material, the method comprising the steps of:
(a) providing a curing system as claimed in claim 1;
(b) positioning the reactive material proximate the emitter port; and
(c) directing radiation within the absorption spectrum of the reactive material into the inlet port until the reactive material is sufficiently cured.
